(19) United States
(12) Patent Application Publication
(10) Pub. No.: US 2006/0037262 A1
(43) Pub. Date: Feb. 23, 2006

(54) Spacer for panes of multilayer insulation glazings

(76) Inventors: Marko Siebert, Essen (DE); Jurgen Kunesch, Heiligenhaus (DE); Karl Ricks, Krefeld (DE)

Correspondence Address: FRIEDRICH KUEFFNER, 317 MADISON AVENUE, SUITE 910, NEW YORK, NY, 10017, US

(21) Appl. No.: 10/532,402

(22) PCT Filed: Oct. 22, 2003
(86) PCT No.: PCT/EP03/11673

§ 371 Date: Apr. 22, 2005

(30) Foreign Application Priority Data
Oct. 25, 2002 (DE) 102 50 052.5

(51) Int. Cl. E06B 9/01; E06B 3/68

(52) U.S. Cl. 52/204.593; 52/204.6; 52/786.13

(57) ABSTRACT

The invention relates to a spacer for panes (20) of multilayer insulation glazings, particularly for use in windows, doors, or similar. Said spacer consists of a hollow profile that is filled with a moisture-absorbing material. In order to obtain a good seal with a low quantity of sealant in the peripheral bond, the spacer is provided with webs (3) which protrude from the rear wall (5) of the hollow profile. Such a web (3) delimits a space (24) for receiving a sealant along with a disk that is adjacent to said web (3). No sealant needs to be applied to the outer surface (17) of the rear wall (5).

The invention concerns a spacer for panes of multilayer insulating glass units, especially for use in windows, doors, or the like, which consists of a hollow section that is filled with a moisture-absorbing material. Spacers of this type can be joined by bending and/or by corner keys to form a spacer frame, which is arranged between the panes of a multilayer insulating glass unit and then sealed by means of an edge seal. One-step or two-step systems for the edge sealing are known. In one-step systems, preferably hot-melt or butyl sealant is applied as the edge sealant in a sealant width of at least 7 mm. In two-step systems, a distinction is made between the primary sealant, preferably butyl sealant, which is preferably placed in the area of the side walls of the hollow section between the spacer and the panes of glass, and the secondary sealant, for example, silicone, polyurethane or polysulfide. This secondary sealant is applied in sealant widths of at least 4 mm, and a minimum coverage of the back of the spacer of 2 mm is strived for. The butyl sealant makes the joint water vapor-tight and gas-tight. The secondary sealant ensures stability of the edge seal.

A great deal of effort has been applied to the problem of developing spacer sections which realize an especially tight edge seal. EP 0 586 121 describes an insulating unit in which better edge sealing is produced with the use of more sealing material. In this regard, the spacer sections are modified especially in such a way that an arcuate recess is provided in the side wall of the spacer. As a result, more primary sealant can be placed in the edge seal at a constant sealant width, and, in particular, the distance between the side wall of the spacer and the pane increases, at least in certain regions. Since the sealant costs have a significant impact on the total price of the insulation system, a solution of this type, in which significantly more sealant is used, is expensive and thus undesirable.

German Early Disclosure DE 100 23 541 A1 describes a spacer section in which the sealing is improved by enlarging the sealant width for the primary sealant. This is accomplished with a spacer section that has side walls with sidepieces that are extended beyond the visible surface. Each end of these sidepieces has a thickened region that rests on the panes and thus bounds a larger sealant space. However, the improved sealing is achieved here with the same amount or a slightly larger amount of sealant. However, to achieve a less expensive insulating glass unit, one would wish to reduce the amount of sealant.

The documents BE 1 000 298, U.S. Pat. No. 4,811,532, and DE 22 24 264 also describe an increase in the sealant width. Two webs that project above the rear wall of the spacer hollow section are provided. The first two cited documents show webs that are oriented parallel to the panes. These webs are generally very long, so that a large amount of sealant can be provided in the space between each web and the pane adjacent to it. Accordingly, it is still necessary to use a large amount of sealant. German Early Disclosure DE 22 24 246 shows a spacer section with webs that extend from the rear wall of the spacer section at an inclination. These webs are inclined towards the panes, so that the space between the webs forms a conical groove for the positive-locking seating of a fastening element. The space between each web and the pane can be filled with sealant. This document provides no information about optimizing the amount of sealant. Moreover, the webs inclined towards the panes are unsuitable for flexible spacers.

The objective of the present invention is thus to produce equally good or better sealing of a multilayer insulating glass unit with a smaller amount of sealant.

This seemingly contradictory objective is achieved with a spacer that has the features of Claim 1. The webs, which project above the rear wall of the hollow section, bound a space for holding the sealant, i.e., in the case of one-step systems, for example, the hot-melt sealant, and in the case of two-step systems, the secondary sealant. No sealant is provided in the area between the two webs, i.e., the rear wall of the hollow section is not covered with sealant. To provide a sufficiently large space for holding the sealant, the other part of the rear wall, i.e., the part of the rear wall that lies outside the webs, is formed as a step that lies at a lower level.

The application of sealant on the outer surface of the rear wall of the hollow section is also unnecessary, since when metal spacers are used, the metal material ensures a better gastight and moistureproof seal than the aforementioned sealants that are well known for use in edge seals. The minimum sealant width of 7 mm that is required by the quality association for a one-step or two-step system can also be maintained with the use of the spacer of the invention.

In one embodiment of the spacer of the invention, in which the walls produce an almost box-like cross section, a space for the primary sealant can be bounded by the respective side wall that faces the glass pane. The required minimum sealant width can also be achieved in this embodiment. The side walls run approximately parallel to the panes, and their lower corners approach the pane in the direction of the inner wall. These corners constitute a boundary between the primary sealant space and the interior space between the panes. This primary sealant space narrows sharply at this point, so that it is difficult for the primary sealant to penetrate the interior space between the panes. The distance between the lower corners, where the side walls meet the inner wall, is equal to the width of the spacer. In an advantageous way, this shape of the hollow section reduces friction during shipment and during guidance of the spacer sections in bending devices or other processing machines, since the section no longer has to be grasped along the entire side wall to move it but rather only at the outermost points, the corners that are formed by the inner wall and the side wall, namely, the so-called boundary points.

In addition, the primary sealant width can be formed or increased by sidepieces, which extend the side walls of the hollow section and project beyond the inner wall, which faces the interior space between the panes and is provided with perforations.

A space for holding the secondary sealant is laterally bounded on one side by the pane and on the other side by a web that projects from the rear wall. When the rear wall is formed with a step that lies outside the webs and at a lower level than the rest of the rear wall, the space for holding the secondary sealant is bounded towards the bottom by this step of the rear wall. The size of the space for holding the secondary sealant varies according to the length and positioning of the webs of the invention. The webs should be at least 1.5 mm long. Preferably webs with a length of 1.5 to 3 mm are possible for flexible spacers. In addition, in a preferred embodiment, the portion of the rear wall outside the webs is formed as a step to increase the space for holding the secondary sealant. In the case of spacer sections that do not have to be bent but rather are joined by corner keys to form a spacer frame, the length of the webs can be extended to a maximum of 5 mm. The minimum length of 1.5 mm results from the fact that an adequate surface for the adhesion of the secondary sealant must be made available.

In addition, low-contact stacking of the spacer sections is made possible in an advantageous way by providing a shadow groove on the front side of the spacer. This avoids the usual full-surface contact between the visible surfaces and the backs of the sections when conventional spacers are stacked. With the spacers of the invention, only the ends of the two webs touch the visible surface, so that in the event of possible contact corrosion or fretting corrosion, only two lines can form on the visible surface, and besides, these lines are located in the shadow grooves.

The webs can project perpendicularly from the rear wall, or they can project obliquely. Oblique webs are preferably formed in such a way that they slope away from the panes, starting from the rear wall, i.e., they slope towards each other. This oblique position of the webs allows good flexibility of the spacer, preferably at the corners as well, so that the spacer can be bent into a spacer frame. The spacer section does not break apart at the corners, since the webs rest against the rear wall in this region. Furthermore, the better flexibility of the spacer of the invention results from the fact that in the spacer section of the invention, compared to spacers of the same height, the rear wall moves closer to the neutral axis, and thus elongation of the rear wall during bending is reduced. The spacer of the invention can be bent both filled and unfilled; for the same overall height, the spacer section's interior space for holding the drying agent is smaller, i.e., in addition, less drying agent is needed.

In another preferred embodiment, the walls of the spacer have a concave shape, i.e., they are curved towards the interior space. This results in better tightness of the insulating glass unit, since the spacer can compensate possible movement of the glass pane caused by the effects of wind and climate.

Furthermore, this spacer shape is conducive to better flexibility of the section, since the rear wall and the inner wall are oriented towards the neutral axis and thus are less stressed during bending. Concave side walls also increase the primary sealant space, so that in this case, a larger butyl sealant reservoir can be provided.

The invention is explained below on the basis of an embodiment illustrated in the drawings. However, the invention is not limited to this embodiment.

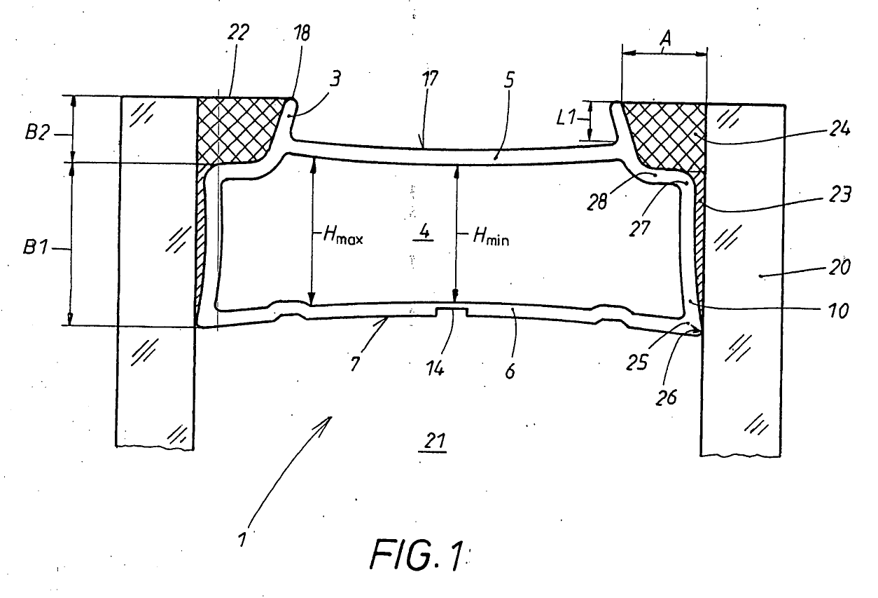

FIG. 1 shows a cross section through another spacer in accordance with the invention, which is installed between two panes.

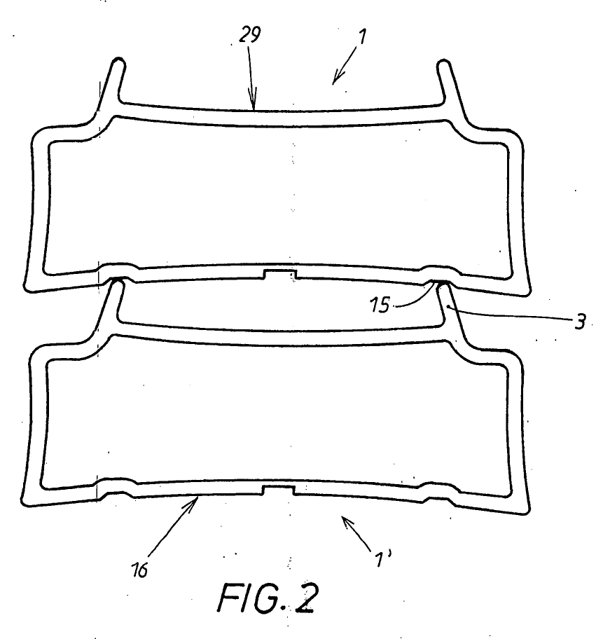

FIG. 2 shows a cross section through two spacers of the invention in accordance with FIG. 1, which are stacked one on top of the other.

A spacer of the invention for multilayer insulating glass units consists of a hollow section 1, whose interior space 4 contains a moisture-absorbing material, which is not shown in the drawings. This interior space 4 is bounded by two side walls 10, the rear wall 5 and the inner wall 6. The inner wall 6 has a weakened region. This region of wall weakening has perforations 14, which allow communication between the interior space 21 between the panes and the interior space 4 of the hollow section 1 for the purpose of moisture absorption. In accordance with the invention, the hollow section 1 has two webs 3 that project above the rear wall 5 of the hollow section 1. These webs 3 are inclined away from the panes 20 and have a length L1. In principle, the webs 3 can be arranged in any desired place on the rear wall 5. However, it is advantageous to place the webs 3 in the region of the rear wall 5 of the hollow section 1 where the rear wall 5 makes a transition to the step 28. The step 28 and the side wall 10 form a corner 27.

FIGS. 1 and 2 show a box-like hollow section 1. The interior space 4 of this spacer hollow section 1 is bounded by a rear wall 5 and inner wall 6 that are approximately parallel and by side walls 10 that are approximately parallel. The webs 3 are arranged some distance from the glass panes 20 to produce a sufficiently large space 24 for holding the secondary sealant. Furthermore, the webs 3 arising from the rear wall 5 are arranged obliquely and are inclined towards each other. This is an advantage especially during the bending of spacer frame corners. Perpendicular webs would have to be deformed over the high edge during bending, which is problematic and leads to the breaking of the webs or even of the section in this corner region. As a result of the oblique position of the webs 3, the webs 3 rest against the outer surface 17 of the rear wall 5 during bending of the corners, and the hollow section 1 does not sustain any damage.

In the rectangular hollow section 1 shown in FIG. 1, the space 23 for the primary sealant is laterally bounded by the side wall 10 and the pane 20 and preferably narrows towards the bottom. The side wall 10 has a lower corner 25 where it meets the inner wall 6. This corner 25 is formed in such a way that it constitutes a lower boundary 26 for the space 23. There is no direct contact between the corner 25 and the glass pane 20. Nevertheless, the primary sealant is kept essentially in the space 23. The upper corner 27 of each side wall 10, on the other hand, is located some distance from the pane 20 in the example shown in FIG. 3, so that the space 23 for the primary sealant and the space 24 for holding the secondary sealant merge with each other. This can be advantageous especially in insulating glass units that are subject to large shearing forces. As a result of the fact that the corner 27 is set back from the pane compared to the lower corner 25, the glass pane 20 is able to tilt at a greater angle when it is subjected to compressive loads, without this causing the sealant to break away from the pane 20 and the unit to become untight.

A minimum sealant width of 7 mm for one-step or two-step systems is required for multilayer insulating glass units. The spaces 23 for the primary sealant and the spaces 24 for holding the secondary sealant, which are shown in the examples, can also be used for a one-step sealant system.

The required width B1 of the primary sealant surface is the longest dimension of the space 23. The sealant widths B1 and B2 are shown in FIG. 1. The width B1 is at least 3 mm. The width B2 of the secondary sealant surface runs as far as the end face 18 of the web 3 or the end face 22 of the glass pane 20.

However, the end face 18 of the webs 3 does not have to end at the same level as the end face 22 of the glass panes 20. The secondary sealant is provided in the two spaces 24 between each web 3 and the adjacent pane 20. The space 24 for holding the secondary sealant is bounded below by the transition to the space 23. In the example shown in FIG. 1, the space 24 is bounded below essentially by the outer regions of the rear wall 5. To produce a sufficiently large space 24, the rear wall 5 is formed as a step 28, which is positioned lower than the rear wall 5.

The outer surface 17 of the rear wall 5 is not covered with sealant over its full length, i.e., the amount of secondary sealant that must be applied is reduced. This has no adverse effects, especially in regard to the tightness of the multilayer insulating glass unit. In the case of spacer sections that are bent to form a spacer frame, the rear wall can be covered at the corners with secondary sealant to guarantee tightness. In any case, this means significant savings of the expensive secondary sealant, for example, polysulfide. The amount of secondary sealant depends on the size of the space 24, which can be affected, on the one hand, by the distance A of the web 3 from the pane 20 and, on the other hand, by the length L1 of the web 3. To guarantee good adhesion of the secondary sealant, the length L1 of the web 3 should be at least 1.5 mm. The webs 3 are limited to a maximum of 3 mm for flexible spacers and to a maximum of 5 mm for other spacers.

For webs 3 which in themselves would touch the visible surface 7, the hollow sections 1, 1′ are stacked in such a way, as FIG. 2 shows, that the ends of the webs 3 fit into shadow grooves 15. Fretting corrosion or contact corrosion on the visible surface 7 is prevented, or, if it does occur, it is not visible on the visible surface 7 as a decorative defect, since it disappears in the shadow groove 15 and also remains limited to this shadow groove.

The hollow section 1 of the invention is characterized in an advantageous way by a comparatively small interior space 4. Compared to previously known spacer sections, the hollow section 1 of the invention has a smaller maximum height Hₘₐₓ. This is a result of the displacement, relative to previously known spacers, of the rear wall 5 in the direction of the interior space 4.

Furthermore, the aforementioned concavity 16 of the inner wall 6 results in an additional reduction of the interior space 4 for the moisture-absorbing material. As FIG. 1 shows, the maximum height Hₘₐₓ of the interior space 4 is reduced to a minimum height Hₘᵢₙ of the interior space 4 in the area of the perforation 14. Less moisture-absorbing material can be used for the spacer as a result of the smaller interior space 4. A concavity 29 of the rear wall 5 can also be provided. The concavities 16, 29 also allow better bending of the hollow section 1, since the concavities 16, 29 cause the rear wall 5 and the inner wall 6 of the hollow section 1 to move closer to the neutral axis and to be less strongly elongated or compressed during bending.

As has already been mentioned, the object of the invention is not limited to the embodiments of FIGS. 1 and 2. The invention also concerns spacers that consist of an open hollow section, in which the inner wall 6 is totally or partially eliminated. In these cases as well, it can also be advantageous to provide webs 3 that extend from the rear wall 5. Other embodiments are also conceivable.

The spacers that have been described are preferably made of metal, especially aluminum or an aluminum alloy. The illustrated embodiments are extruded spacers.

However, the invention can also be realized with coextruded or roll-formed spacer sections made of steel, high-grade steel or plastic.

### LIST OF REFERENCE NUMBERS

1, 1′ hollow section
3 web
4 interior space
5 rear wall
6 inner wall
7 visible surface
10 side wall
14 perforation
15 shadow groove
16 concavity
17 outer surface of 5
18 end face of 3
20 pane
21 interior space between the panes
22 end face of 20
23 space (for holding primary sealant)
24 space (for holding secondary sealant)
25 lower corner
26 boundary
27 upper corner
28 step of 5
29 concavity
A distance from 3 to 20
B1 width of the primary sealant surface
B2 width of the secondary sealant surface
Hₘₐₓ maximum height of 4
Hₘᵢₙ minimum height of 4
L1 length of the webs 3

1. Spacer for panes of multilayer insulating glass units, especially for use in windows, doors or the like, which consists of an open or closed, rectangular hollow section (1), which can be filled with moisture-absorbing material and whose interior space (4) for the moisture-absorbing material is bounded by at least two side walls (10) and a rear wall (5), wherein the interior space (4) communicates with the space (21) between the panes; two webs (3) that project above the rear wall (5) of the hollow section (1) are provided, each of which forms a boundary of a sealant-filled space (24), which is bounded on the opposite side by a pane (20); the outer surface (17) of the rear wall (5) is not covered with sealant between the webs (3); and the webs (3) are oriented parallel to the panes (20) or are inclined towards each other, wherein to provide a sufficiently large space (24) for holding the sealant, the part of the rear wall (5) that lies outside the webs (3) is formed as a step (2.8) that lies at a lower level:

2. Spacer in accordance with claim 1, wherein the webs (3) have a length (L1) of at least 1.5 mm.

3. Spacer in accordance with claim 2, wherein the webs (3) have a length (L1) of at most 5 mm.

4. Spacer in accordance with claim 2, wherein the webs (3) of a flexible spacer have a length (L1) of 1.5 to 3 mm.

5. Spacer in accordance with claim 1, wherein the closed hollow section has an interior space (4) with a rectangular cross section, such that the interior space (4) is bounded in the direction of the space (21) between the panes by an inner wall (6) that is provided with perforations (14), and the side walls (10) and the adjacent panes (20) form a space (23) for the sealant.

6. Spacer in accordance with claim 5, wherein the lower corner (25) of the side wall (10) is formed in such a way that it constitutes a lower boundary (26) for the space (23).

7. Spacer in accordance with claim 5, wherein the sealant in the space (23) is a primary sealant, preferably butyl sealant, and the sealant in the space (24) is a secondary sealant, preferably polysulfide, polyurethane, or silicone.

8. Spacer in accordance with claim 1, wherein the visible surface (7) of the inner wall (6) of the hollow section (1) is provided with two shadow grooves (15), into which the ends of the webs (3) of the hollow section (1′) fit when the hollow sections (1, 1′) are stacked.

9. Spacer in accordance with claim 1, wherein it consists of metal, preferably aluminum or an aluminum alloy.

10. Spacer in accordance with claim 1, wherein it consists of metal, preferably steel or high-grade steel.

11. Spacer in accordance with claim 1, wherein it consists of coextruded plastic.
